(19) United States
(12) Patent Application Publication
(10) Pub. No.: US 2014/0291555 A1
(43) Pub. Date: Oct. 2, 2014

(54) RADIATION GENERATION APPARATUS AND RADIOGRAPHIC APPARATUS

(71) Applicant: CANON KABUSHIKI KAISHA, Tokyo (JP)

(72) Inventor: Shichihei Sakuragi, Tokyo (JP)

(21) Appl. No.: 14/226,652

(22) Filed: Mar. 26, 2014

(30) Foreign Application Priority Data
Mar. 29, 2013 (JP) 2013-073014

(51) Int. Cl. G21K 5/00

(52) U.S. Cl. CPC G21K 5/00
USPC 250/493.1

(57) ABSTRACT

A radiation generation apparatus and a radiographic apparatus that can be easily transported and whose radiation generation unit can be installed according to the radiographing region of the object include a supporting mechanism (supporting column, arm) that supports a radiation generation unit that generates radiation, and a supporting base that supports the supporting mechanism. The supporting mechanism is removable from the supporting base together with a power source unit that supplies power to the radiation generation unit.

### BACKGROUND OF THE INVENTION

1. Field of the Invention

The present invention relates to a radiation generation apparatus and a radiographic apparatus that have a radiation generation unit that generates radiation to irradiate an object.

2. Description of the Related Art

In recent years, a portable radiographic apparatus has become increasingly useful. When radiography is performed using a portable radiographic apparatus, a radiation generation unit is installed according to the radiographing region of the object.

A portable radiographic apparatus typically integrates a radiation generation unit and a detecting apparatus that detects radiation radiated from the radiation generation unit, with a holding arm therebetween (Japanese Patent Laid-Open No. 2012-70835). A portable radiographic apparatus of this type typically includes a moving portion having an arm which is used to attach a radiation source (Japanese Patent Laid-Open No. 2012-30062).

In the radiographic apparatus of Japanese Patent Laid-Open No. 2012-70835, the detecting apparatus is disposed on the back of the object and then position adjustment of the detecting apparatus is performed. Therefore, various measures that do not put a load on the object have been desired.

In the radiographic apparatus of Japanese Patent Laid-Open No. 2012-30062, the moving portion has a mechanism that holds a detecting apparatus, and the radiographic apparatus cannot be easily carried. Therefore, various measures have been desired.

### SUMMARY OF THE INVENTION

The present invention provides a radiation generation apparatus and a radiographic apparatus that can be easily carried and whose radiation generation unit can be installed according to the radiographing region of the object.

A radiation generation apparatus of the present invention includes a supporting mechanism that supports a radiation generation unit that generates radiation, and a supporting base (moving portion) that supports the supporting mechanism. The supporting mechanism is removable from the supporting base (moving portion).

Further features of the present invention will become apparent from the following description of exemplary embodiments with reference to the attached drawings.

### BRIEF DESCRIPTION OF THE DRAWINGS

FIG. 1 is a diagram showing the overall structure of a radiation generation apparatus in accordance with the present invention.

FIG. 2 is a diagram showing a supporting base of the radiation generation apparatus in accordance with the present invention.

FIGS. 3A and 3B are diagrams showing a connected form of a supporting column and the supporting base of the radiation generation apparatus in accordance with the present invention.

FIG. 4 is a diagram showing a stored form of the radiation generation apparatus in accordance with the present invention.

FIGS. 5A and 5B are diagrams showing a separated form of the radiation generation apparatus in accordance with the present invention.

FIGS. 6A and 6B are diagrams showing a moving portion of the radiation generation apparatus in accordance with the present invention.

FIG. 7 is a diagram showing a connected form of the supporting column and the moving portion of the radiation generation apparatus in accordance with the present invention.

FIG. 8 is a diagram showing a rotating portion of the radiation generation apparatus in accordance with the present invention.

FIGS. 9A and 9B are diagrams showing a second embodiment of the radiation generation apparatus in accordance with the present invention.

FIGS. 10A and 10B are diagrams showing a third embodiment of the radiation generation apparatus in accordance with the present invention.

FIGS. 11A and 11B are diagrams showing a fourth embodiment of the radiation generation apparatus in accordance with the present invention.

### DESCRIPTION OF THE EMBODIMENTS

Exemplary embodiments of the present invention will be described with reference to the drawings below.

### First Embodiment

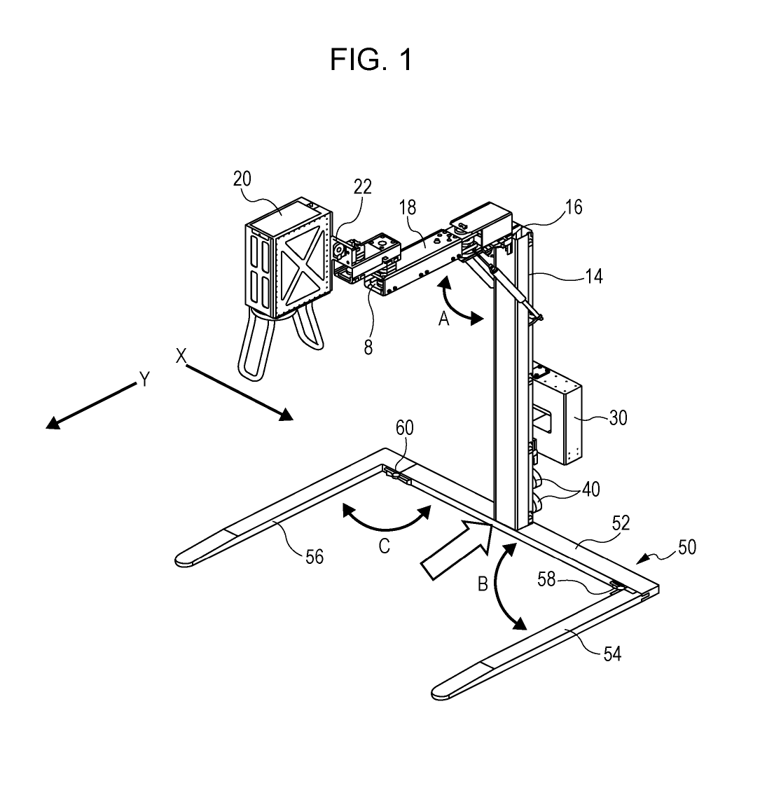

FIG. 1 is a diagram showing the configuration of a radiation generation apparatus of this exemplary embodiment. FIG. 1 shows a perspective view of the radiation generation apparatus at the time of radiography.

The radiation generation apparatus has a supporting base 50 that is installed on a floor, a supporting column 14 that is vertically erected on the supporting base 50, an arm 18 that is rotatably installed to the supporting column 14, and a radiation generation unit 20 that is rotatably installed to the arm 18 and that generates radiation. In order to make the radiation generation apparatus as compact as possible, the radiation generation apparatus does not have a display apparatus that displays an image. The supporting column 14 and the arm 18 can be described as a supporting mechanism that supports the radiation generation unit 20 that generates radiation.

As shown in FIG. 1, a power source unit 30 that supplies power to the radiation generation unit 20 is fixed to the supporting column 14. Specifically, the power source unit 30 is installed at the lower end of the supporting column 14, and the supporting column 14 and the power source unit 30 are integrated. The power source unit 30 is installed on the side (the rear side in FIG. 1) opposite to the side where the radiation generation unit 20 is installed (the front side in FIG. 1). The power source unit 30 is installed on such a side surface of the supporting column 14 that the power source unit 30 is not interfered with by the arm 18 and the radiation generation unit 20 when the arm 18 is folded. The power source unit 30 is composed of relatively heavy elements. By installing the power source unit 30 at the lower end (the side closest to the floor) of the supporting column 14, the balance of the radiation generation apparatus can be stabilized. Although a power cable for supplying power from the power source unit 30 to the radiation generation unit 20 is not depicted, it may be disposed inside the supporting column 14 and the arm 18.

In general, in a radiation generation apparatus, it is desired to acquire an image having good image quality, and therefore a high-power radiation generation unit 20 is required. However, the more high-power a radiation generation unit 20 is, the heavier it tends to be. In a radiation generation apparatus in which the workability during transportation and assembly is important, the weight of a radiation generation unit 20 and the image quality are in the relationship of trade-off. By reducing the weight of a holding mechanism (supporting column 14, arm 18) of the radiation generation unit 20, the whole radiation generation apparatus can be reduced in weight. However, if the weight of the holding mechanism is too small compared to the weight of the radiation generation unit 20, the weight balance is lost, and the possibility of falling is raised. So, by installing the power source unit 30 on the side of the supporting column 14 opposite to the position of the radiation generation unit 20, the weight balance can be secured.

As described above, in order for the radiation generation apparatus to be operable even in a poor power supply environment, a power source unit 30 with a battery is connected to the radiation generation unit 20, and the radiation generation apparatus thereby becomes capable of radiography even in an environment where no power source is available. At that time, by utilizing the weight of the power source unit 30, the balance with the weight of the radiation generation unit 20 can be easily secured.

The arm 18 is connected to the radiation generation unit 20 at one end, and is connected to the supporting column 14 at the other end. The arm 18 supports the radiation generation unit 20, and has a predetermined length. As shown in FIG. 1, the arm 18 may have an elongating and contracting mechanism that elongates and contracts in the longitudinal direction of the arm 18 and a rotating mechanism that rotates the arm 18 with a multijoint mechanism that can be bent variously. By elongating the arm 18 in a predetermined direction, the radiation generation unit 20 can be moved toward the object.

The shape of the arm 18 is not limited to a linear shape such as that shown in FIG. 1 and may be a curved shape. The arm 18 may be composed of a plurality of members, for example, rod members, cylindrical members, or string members (net structure). That is, the arm 18 may have any shape and structure as long as it supports the radiation generation unit 20.

The multijoint mechanism of the arm 18 is realized by a joint portion 8 that divides the arm 18 at substantially the center and that connects the divided arm 18. By rotating the arm 18 about the joint portion 8, the position in the horizontal direction of the radiation generation unit 20 can be adjusted. The radiation generation unit 20 can be quickly positioned by the joint portion 8, and therefore the work efficiency of the radiation generation apparatus is improved.

A torque hinge may be provided inside the joint portion 8. On a mattress for home medical care or in a disaster site where the radiation generation apparatus is installed, the horizontally of the installation surface is not always secured. Therefore, there is a possibility that the joint portion 8 rotates due to the weight of the radiation generation unit 20 and the arm 18 is not fixed in an appropriate position. Therefore, a fixing mechanism needs to be provided so that the arm 18 does not move against the intention of the operator. By providing a torque hinge, resistance force is generated in the joint portion 8, and movement against the intention of the operator can be suppressed. At this time, the torque of the torque hinge is smaller than the torque generated by the operation force when the operator adjusts the position of the radiation generation unit 20.

The arm 18 can be rotated about the upper end of the supporting column 14. Specifically, as shown in FIG. 1, the supporting column 14 has an arm hinge portion 16 for rotating the arm 18 in a predetermined rotation direction (A direction). The arm 18 has a range of rotation of about 180 degrees in the predetermined rotation direction (A direction). The arm 18 bends to the side opposite to the side where the power source unit 30 is installed.

The arm hinge portion 16 connects the arm 18 and the supporting column 14, and has a mechanism capable of opening and closing the arm 18 with respect to the supporting column 14. When the arm 18 is folded about the arm hinge portion 16, the arm 18 is almost parallel to the supporting column 14.

As described above, by rotating the arm 18 in a predetermined rotation direction (A direction), the arm hinge portion 16 can be converted from a form in which the arm 18 extends upward or laterally as shown in FIG. 1 to a form in which the arm 18 is stored together with the radiation generation unit 20. The form in which the arm 18 extends upward or laterally shown in FIG. 1 is a state where the radiation generation unit 20 is located near an object. The form in which the arm 18 is stored together with the radiation generation unit 20 is a state where the arm 18 is folded, and the arm 18 is almost parallel to the supporting column 14, that is, the radiation generation unit 20 is disposed near the floor. The form in which the arm 18 is stored together with the radiation generation unit 20 will be described later.

The shape of the supporting column 14 is not limited to a linear shape such as that shown in FIG. 1 and may be a curved shape. The supporting column 14 may be composed of a plurality of members, for example, rod members, cylindrical members, or string members (net structure). That is, the supporting column 14 may have any shape and structure as long as it rotatably supports the arm 18.

A rotating portion 22 capable of rotating the radiation generation unit 20 is installed between the radiation generation unit 20 and the arm 18. By rotating the radiation generation unit 20, positioning can be performed relative to the object, and radiation can be sent in a desired direction.

The supporting base 50 has a U-shape with angular corners or a U-shape with rounded corners. The supporting base 50 keeps the balance of the radiation generation apparatus, and realizes a form in which the supporting base 50 is not installed directly below (vertically below) the radiation generation unit 20. A detecting apparatus is installed directly below (vertically below) the radiation generation unit 20. That is, a detecting apparatus is installed in a region where the supporting base 50 is not installed.

Specifically, the supporting base 50 has a plurality of leg portions 52, 54, and 56. The plurality of leg portions 52, 54, and 56 are each in contact with a floor (or a bed). The plurality of leg portions 52, 54, and 56 are placed and installed on the floor so as to keep the radiation generation apparatus in balance. By arranging the plurality of leg portions 52, 54, and 56, the shape of the supporting base 50 can be made into a U-shape with angular corners or a U-shape with rounded corners. At the time of radiography, the supporting base 50 has a U-shape with angular corners or a U-shape with rounded corners.

The supporting base 50 has a first leg portion 52 to be connected to the supporting column 14, a second leg portion 54 connected to the first leg portion 52, and a third leg portion 56 connected to the first leg portion 52. The second leg portion 54 and the third leg portion 56 are about the same length.

Here, the longitudinal direction of the first leg portion 52 is denoted as X direction, and a direction perpendicular to the longitudinal direction of the first leg portion 52 is denoted as Y direction. At the time of radiography, as shown in FIG. 1, the second leg portion 54 is installed perpendicularly to the first leg portion 52. The third leg portion 56 is installed perpendicularly to the first leg portion 52. At this time, the second leg portion 54 is parallel to the third leg portion 56. The second leg portion 54 and the third leg portion 56 are installed so as to extend in the Y direction perpendicular to the longitudinal direction of the first leg portion 52, the direction in which the radiation generation unit 20 is installed.

The distal end of the second leg portion 54 has an inclined surface (tapered portion) so that the thickness of the distal end of the second leg portion 54 decreases gradually. The distal end of the second leg portion 54 is the side opposite to the side connected to the first leg portion 52. The bottom surface of the second leg portion 54 is flat and in contact with the floor, and the height of the upper surface of the second leg portion 54 decreases toward the distal end. Since the second leg portion 54 has an inclined surface (tapered portion) at its distal end as described above, the thickness of the distal end of the second leg portion 54 can be reduced.

Similarly, the distal end of the third leg portion 56 has an inclined surface (tapered portion) so that the thickness of the distal end of the third leg portion 56 decreases gradually. The distal end of the third leg portion 56 is the side opposite to the side connected to the first leg portion 52. The bottom surface of the third leg portion 56 is flat and in contact with the floor, and the height of the upper surface of the third leg portion 56 decreases toward the distal end. Since the third leg portion 56 has an inclined surface (tapered portion) at its distal end as described above, the thickness of the distal end of the third leg portion 56 can be reduced.

The inclined surface (tapered portion) at the distal end of the second leg portion 54 is about the same length as the inclined surface (tapered portion) at the distal end of the third leg portion 56. The length of the inclined surfaces (tapered portions) is appropriately a predetermined length (for example, within the range of 10 cm to 50 cm), and can be set arbitrarily.

The supporting base 50 has a plurality of joint portions 58 and 60 so that the plurality of leg portions 54 and 56 constituting the supporting base 50 can be folded. Specifically, the supporting base 50 has a joint portion 58 between the first leg portion 52 and the second leg portion 54. The joint portion 58 can make the second leg portion 54 foldable. Thanks to the joint portion 58, the second leg portion 54 can be rotated in the B direction. The joint portion 58 has a movable range of about 90 degrees. The joint portion 58 can change the longitudinal direction of the second leg portion 54 from the Y direction to the X direction. As described above, the second leg portion 54 can be folded about the joint portion 58.

Similarly, the supporting base 50 has a joint portion 60 between the first leg portion 52 and the third leg portion 56. The joint portion 60 can make the third leg portion 56 foldable. Thanks to the joint portion 60, the third leg portion 56 can be rotated in the C direction. The joint portion 60 has a movable range of about 90 degrees. The joint portion 60 can change the longitudinal direction of the third leg portion 56 from the Y direction to the X direction. As described above, the third leg portion 56 can be folded about the joint portion 60.

The rotation axis of the joint portion 58 that rotates the second leg portion 54 is parallel to the rotation axis of the joint portion 60 that rotates the third leg portion 56. When the second leg portion 54 and the third leg portion 56 are folded, the second leg portion 54 and the third leg portion 56 are parallel to the first leg portion 52.

The difference in shape between the second leg portion 54 and the third leg portion 56 will be described. The shape of the second leg portion 54 near the joint portion 58 is slightly different from the shape of the third leg portion 56 near the joint portion 60. The second leg portion 54 has a linear shape whereas the third leg portion 56 has an L-shape so that, when the second leg portion 54 and the third leg portion 56 are folded and the supporting base 50 is stored, the second leg portion 54 is covered by the third leg portion 56. Therefore, the base of the L-shaped third leg portion 56 has a width greater than the width of the second leg portion 54. At the time of storage, first, the second leg portion 54 is folded. After the linear second leg portion 54 is folded, the L-shaped third leg portion 56 is folded.

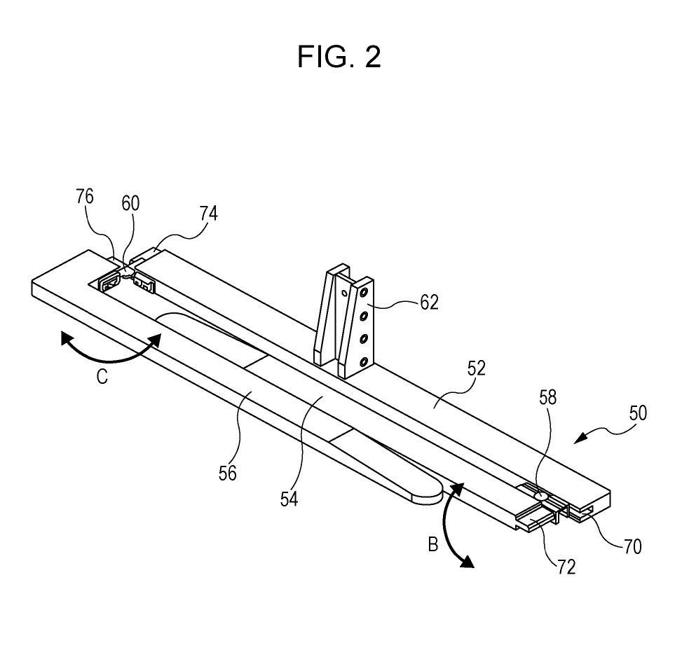

FIG. 2 shows the form of the supporting base 50 at the time of storage. As shown in FIG. 2, when the second leg portion 54 and the third leg portion 56 are folded, the second leg portion 54 and the third leg portion 56 are parallel to the first leg portion 52. The third leg portion 56 covers the second leg portion 54. Thus, the supporting base 50 can be compactly stored. Therefore, the operator can compactly carry the supporting base 50.

As shown in FIG. 2, the supporting base 50 has fitting portions 70 and 72 by which the first leg portion 52 and the second leg portion 54 are fit together, and fitting portions 74 and 76 by which the first leg portion 52 and the third leg portion 56 are fit together.

Specifically, the first leg portion 52 has a recess 70 at one end and has a protrusion 74 at the other end. The second leg portion 54 has a protrusion 72. The protrusion 72 of the second leg portion 54 is provided on the side opposite to the distal end where the inclined surface (tapered portion) is located. The protrusion 72 has a size such that it can be fitted into the recess 70 of the first leg portion 52. When the second leg portion 54 is rotated about the joint portion 58, as shown in FIG. 1, the protrusion 72 of the second leg portion 54 is fitted into the recess 70 of the first leg portion 52, and the second leg portion 54 is fixed to the first leg portion 52.

The third leg portion 56 has a recess 76. The recess 76 of the third leg portion 56 is provided on the side opposite to the distal end where the inclined surface (tapered portion) is located. The recess 76 has a size such that the protrusion 74 of the first leg portion 52 can be fitted into it. When the third leg portion 56 is rotated about the joint portion 60, as shown in FIG. 1, the protrusion 74 of the first leg portion 52 is fitted into the recess 76 of the third leg portion 56, and the third leg portion 56 is fixed to the first leg portion 52.

As described above, at the time of radiography, as shown in FIG. 1, the second leg portion 54 is installed perpendicularly to the first leg portion 52, and the third leg portion 56 is installed perpendicularly to the first leg portion 52. At this time, the second leg portion 54 and the third leg portion 56 are fixed to the first leg portion 52 by the fitting portions 70, 72, 74, and 76.

Although an example is shown in which the supporting base 50 has a plurality of leg portions: a first leg portion 52, a second leg portion 54, and a third leg portion 56, a supporting base 50 that has no joint portions, that is composed of a single member, and that is curved also falls into the concept of a plurality of leg portions.

The plurality of leg portions of the supporting base 50 include the concept of at least two leg portions. Examples of the plurality of leg portions include three leg portions, four leg portions, and five leg portions. The shape of the plurality of leg portions of the supporting base 50 is not limited to a linear shape and may be a curved shape.

The plurality of leg portions of the supporting base 50 may be composed of a plurality of members, for example, rod members, cylindrical members, or string members (net structure).

That is, the plurality of leg portions of the supporting base 50 may have any shape and structure as long as they support a supporting mechanism (supporting column 14) that supports a radiation generation unit that generates radiation.

The radiation generation apparatus has a removal mechanism that makes the supporting base 50 removable from the supporting column 14 at the position of the outline arrow in FIG. 1. Specifically, as shown in FIG. 2, the supporting base 50 has a connection portion 62 that is removably connected to the supporting column 14. The connection portion 62 is a member protruding upward from the first leg portion 52. The supporting column 14 is hollow. By fitting the upward protruding connection portion 62 into the supporting column 14, the supporting column 14 and the first leg portion 52 are connected as shown in FIG. 1. The connection portion 62 may have an inclined surface (tapered portion) at its distal end so that it can be easily connected to the supporting column 14.

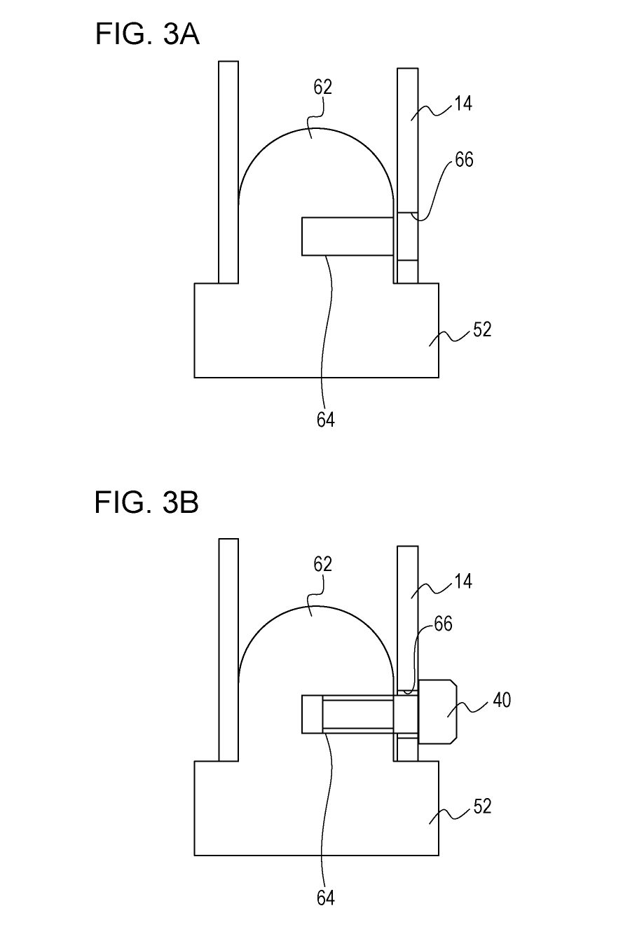

FIGS. 3A and 3B are schematic views showing a connected form and a fixed form of the supporting column 14 and the supporting base 50. FIG. 3A shows a connected form in which the supporting column 14 and the supporting base 50 are connected. FIG. 3B shows a fixed form in which the supporting column 14 is fixed to the supporting base 50 by a fixing portion.

When the supporting column 14 and the supporting base 50 are connected, as shown in FIG. 3A, the connection portion 62 protruding upward from the first leg portion 52 is fitted into the supporting column 14. The radiation generation apparatus has a fixing portion 40 that fixes the connection portion 62 and the supporting column 14. After the supporting column 14 and the connection portion 62 are connected, as shown in FIG. 3B, the operator fixes the connection portion 62 and the supporting column 14 with the fixing portion 40. The fixing portion 40 is, for example, a screw member (male thread portion). In the side surface of the supporting column 14, a hole 66 is provided that has a size such that the fixing portion 40 can be passed through it. The connection portion 62 has a securing mechanism 64 that secures the fixing portion 40. The securing mechanism 64 is a screw-securing mechanism capable of securing a screw member, for example, a female thread portion capable of securing a screw member. As described above, by the fixing portion 40, the supporting base 50 can be connected to the supporting column 14, and the supporting base 50 can be fixed to the supporting column 14. Although only one fixing portion 40 is provided in FIG. 3B, a plurality of fixing portions 40 may be provided.

As shown in FIG. 3A, if the operator releases the fixing by the fixing portion 40, the operator can remove the supporting column 14 from the supporting base 50. Therefore, the operator can carry the supporting base 50 separately from the radiation generation apparatus excluding the supporting base 50 (the components of the radiation generation unit 20, the arm 18, the supporting column 14, and the power source unit 30).

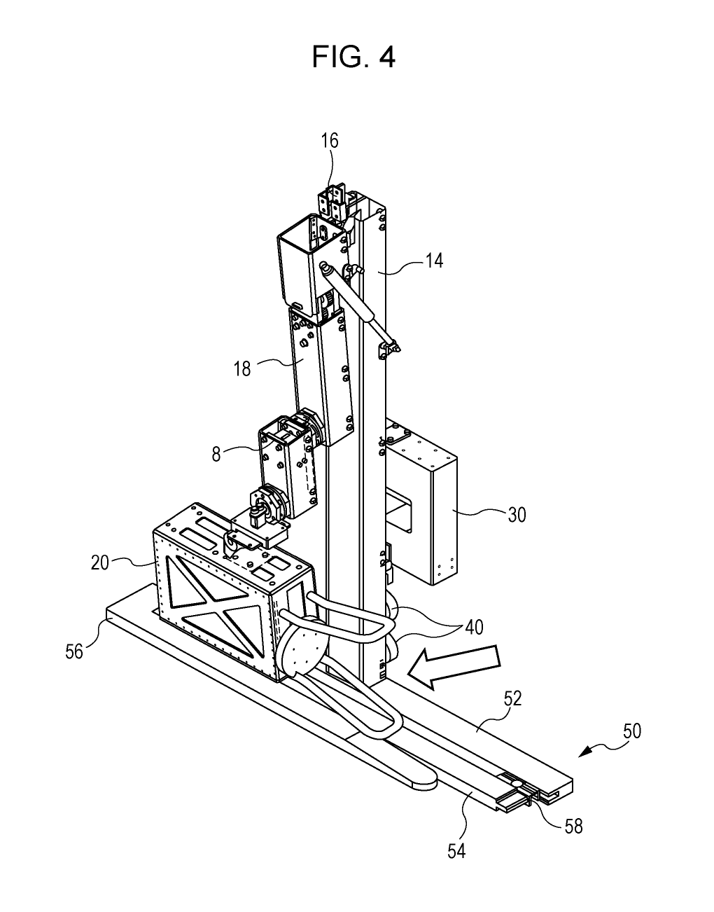

As shown in FIG. 4, the radiation generation apparatus excluding the supporting base 50 separated from the supporting base 50 has at least the radiation generation unit 20, the arm 18, the supporting column 14, and the power source unit 30. At the time of radiography, the operator needs to move the radiation generation unit 20 according to the radiographing region of the object, but need not move the power source unit 30. So, as described above, the radiation generation unit 20 is installed to the arm 18, and the power source unit 30 is installed to the supporting column 14. Thus, the radiation generation unit 20 and the power source unit 30 are installed to different components.

If the power source unit 30 is installed to the arm 18, the arm 18 needs to support the radiation generation unit 20 and the power source unit 30. The supporting column 14 needs to support the radiation generation unit 20, the power source unit 30, and the arm 18. Therefore, in order to support the radiation generation unit 20 and the power source unit 30, the rigidity of the arm 18 needs to be increased. In order to support the radiation generation unit 20, the power source unit 30, and the arm 18, the rigidity of the supporting column 14 needs to be increased. Therefore, the arm 18 and the supporting column 14 need to be increased in thickness and weight, and the radiation generation apparatus excluding the supporting base 50 is increased in weight.

So, in the radiation generation apparatus of this embodiment, the radiation generation unit 20 is installed to the arm 18, and the power source unit 30 is installed to the supporting column 14. Since the radiation generation unit 20 and the power source unit 30 are installed separately as described above, the arm 18 only has to have enough rigidity to support the radiation generation unit 20. Therefore, the arm 18 only has to have enough thickness and weight to support the radiation generation unit 20.

The power source unit 30 is installed at the lower end (the side closest to the floor) of the supporting column 14. The upper end of the supporting column 14 only has to have enough rigidity to support the arm 18 and the radiation generation unit 20. Therefore, the upper end of the supporting column 14 only has to have enough thickness and weight to support the radiation generation unit 20 and the arm 18. That is, compared to a form in which the arm 18 supports the radiation generation unit 20 and the power source unit 30, the radiation generation apparatus excluding the supporting base 50 can be reduced in weight. Therefore, the operator can easily carry the supporting base 50 and the radiation generation apparatus excluding the supporting base 50 separately.

The supporting column 14 may have a handle that the operator holds when carrying the radiation generation apparatus. For example, a handle is installed at the upper end of the supporting column 14. When the supporting base 50 and the radiation generation apparatus excluding the supporting base 50 are separated, the operator can carry the radiation generation apparatus excluding the supporting base 50 by holding the handle and lifting the handle.

When the arm 18 is folded and the arm 18 is stored together with the radiation generation unit 20, the radiation generation unit 20 and the power source unit 30 are installed on the side closest to the floor. Since the radiation generation unit 20 and the power source unit 30, which are relatively heavy, are located near the floor, the operator can stably carry the radiation generation apparatus using the handle.

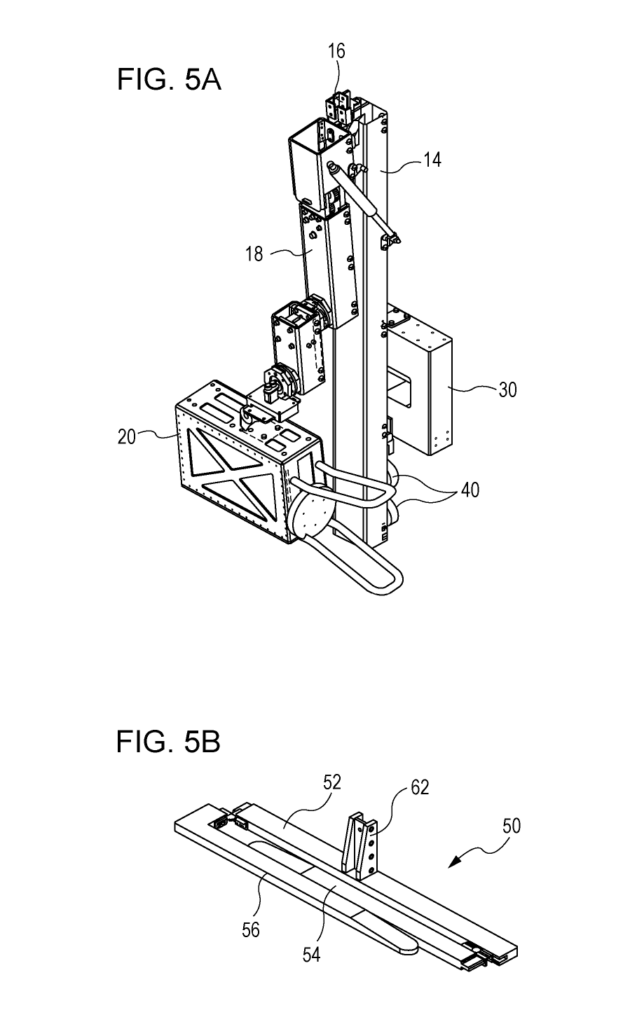

A stored form and a separated form of the radiation generation apparatus will be described specifically with reference to FIGS. 4, 5A, and 5B. FIG. 4 shows a stored form in which the arm 18 and the supporting base 50 are folded and the arm 18 and the supporting base 50 are stored. Specifically, when the arm 18 is folded, the arm 18 is almost parallel to the supporting column 14, and the arm 18 is stored together with the radiation generation unit 20. When the supporting base 50 is folded, the second leg portion 54 and the third leg portion 56 are folded with respect to the first leg portion 52, and the supporting base 50 is stored.

The arm 18 and the supporting column 14 are relatively long components compared to the other components composing the radiation generation apparatus. By locating the arm 18 and the supporting column 14 over the supporting base 50, the radiation generation apparatus can keep balance. The radiation generation unit 20 and the power source unit 30 are relatively heavy components compared to the other components composing the radiation generation apparatus. When the arm 18 is stored together with the radiation generation unit 20, the radiation generation apparatus can keep balance by disposing the radiation generation unit 20 and the power source unit 30 near the floor (near the supporting base 50).

When carrying the supporting base 50 and the radiation generation apparatus excluding the supporting base 50 separately, the operator releases the fixing portion 40 fixing the connection portion 62 of the first leg portion 52 and the supporting column 14. The fixing of the supporting base 50 and the supporting column 14 by the fixing portion 40 is released, and the supporting base 50 and the supporting column 14 become separable. The radiation generation apparatus is separated into two part: the radiation generation apparatus excluding the supporting base (but including the components of the radiation generation unit 20, the arm 18, the supporting column 14, and the power source unit 30) shown in FIG. 5A; and the supporting base 50 shown in FIG. 5B. The operator can carry the supporting column 14 together with the radiation generation unit 20 and the power source unit 30 by lifting the supporting column 14.

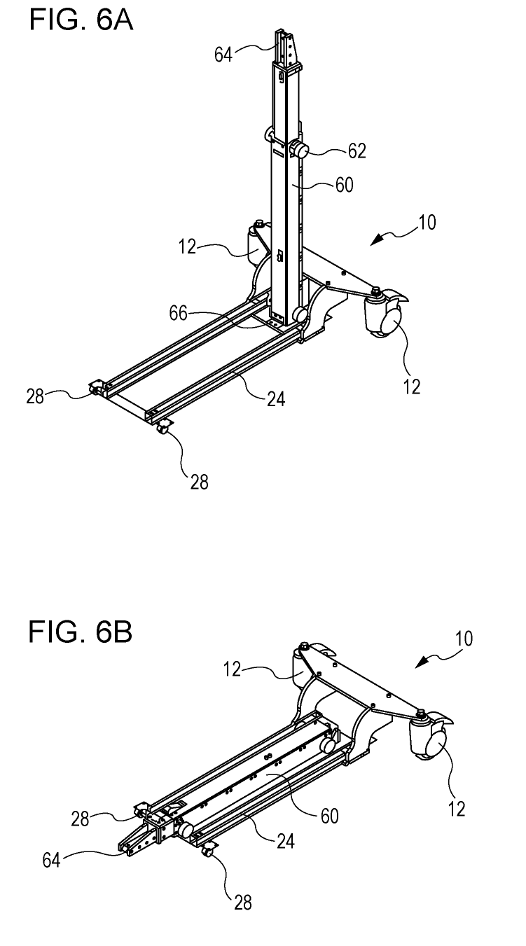

FIGS. 6A and 6B show another form of the supporting base 50. The supporting base 50 may be a moving portion 10 that moves on the floor. The moving portion 10 is capable of moving on the floor. Specifically, the moving portion 10 has wheels 12 that rotate relative to the floor. The wheels 12 are a plurality of tires or casters, and are always placed on the floor. By rotating the wheels 12, the moving portion 10 can be moved in the front-rear direction.

The moving portion 10 has a supporting portion 60 for supporting the supporting column 14. As shown in FIG. 6A, at the time of radiography, the supporting portion 60 is vertically erected in the moving portion 10. The supporting portion 60 has a predetermined length, and has an elongating and contracting mechanism that elongates and contracts in the longitudinal direction of the supporting portion 60. The supporting portion 60 has a lock portion 62 that locks the elongating and contracting of the elongating and contracting mechanism. By releasing the lock of elongating and contracting by the connection portion 62, the supporting portion 60 can be elongated and contracted.

The moving portion 10 has a rotating mechanism 66 that rotates the supporting portion 60. Thanks to the rotating mechanism 66, the supporting portion 60 can be folded forward. As shown in FIG. 6B, by rotating the supporting portion 60, the supporting portion 60 can be made parallel to the floor. By storing the supporting portion 60, the moving portion 10 can be made compact.

The supporting member 24 is a component that supports the radiation generation apparatus. In the form shown in FIGS. 6A and 6B, the components in contact with the floor in the radiation generation apparatus are the wheels 12 of the moving portion 10 and the supporting member 24. The radiation generation apparatus is supported by the wheels 12 of the moving portion 10 and the supporting member 24. By the supporting member 24, the area of contact between the radiation generation apparatus and the floor can be increased. Therefore, for example, even when the radiation generation unit 20 is positioned to the radiographing region of the object, the balance of the radiation generation apparatus can be kept by the supporting member 24.

Specifically, the supporting member 24 has a plurality of leg portions 28 that are rod-shaped members, plate-shaped members, or members having a predetermined rigidity and that are in contact with the floor and support the radiation generation apparatus. The leg portions 28 are installed on the bottom surface of the supporting member 24. The leg portions 28 may be a plurality of moving mechanisms that move on the floor, such as tires or casters.

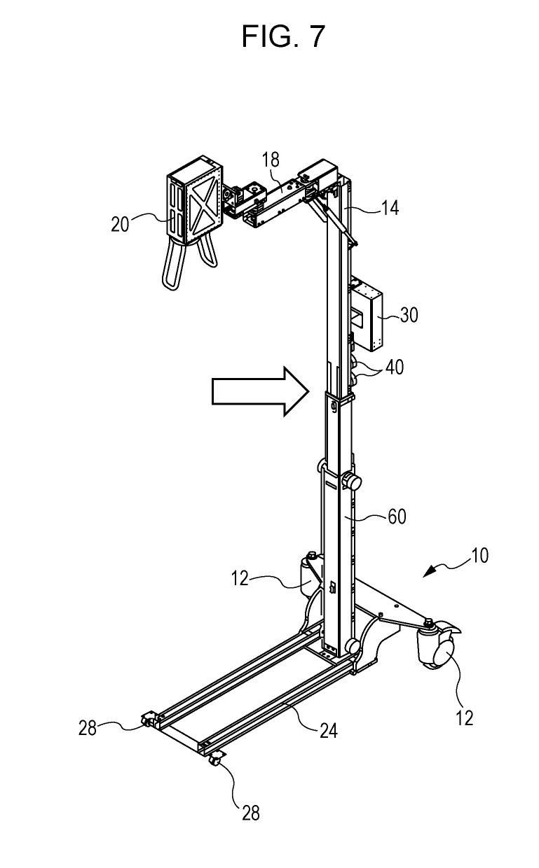

The supporting portion 60 has a connection portion 64 that is removably connected to the supporting column 14. Specifically, the upper end of the supporting portion 60 has a connection portion 64 connected to the supporting column 14. The connection portion 64 is a member protruding upward from the supporting portion 60. The supporting column 14 is hollow. By fitting the upward protruding connection portion 64 into the supporting column 14, the supporting column 14 and the moving portion 10 are connected as shown in FIG. 7.

The radiation generation apparatus has a removal mechanism that makes the supporting column 14 removable from the moving portion 10 at the position of the outline arrow in FIG. 7. The removal mechanism is the same as that of the supporting base 50 described in FIGS. 1 and 2, so the description thereof will be omitted. As with the fixed form shown in FIG. 3B, the operator can fix the connection portion 64 and the supporting column 14 with the fixing portion 40.

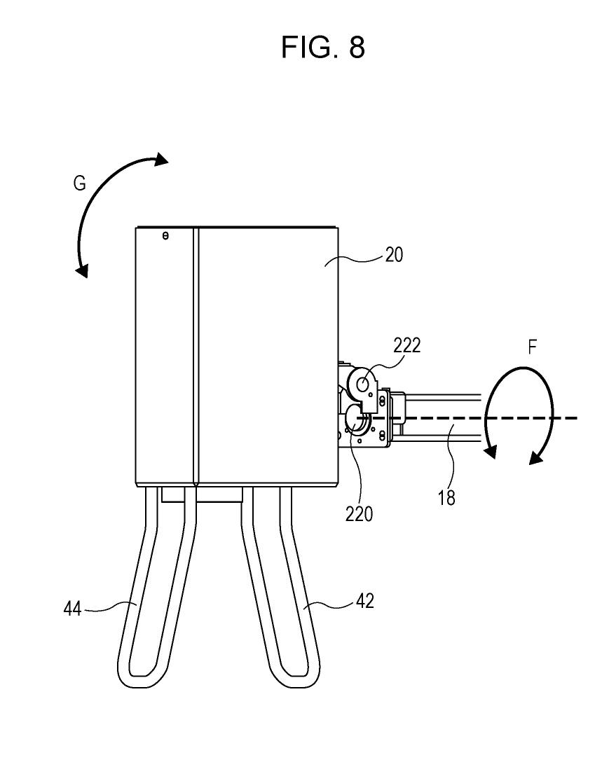

FIG. 8 is a specific explanatory diagram of the rotating portion 22 that rotates the radiation generation unit 20. The rotating portion 22 includes a swivel hinge 220 that rotates the radiation generation unit 20 about an axis parallel to the longitudinal direction of the arm 18, and a tilt hinge 222 that rotates the radiation generation unit 20 about an axis perpendicular to the longitudinal direction of the arm 18. In the rotating portion 22, the swivel hinge 220 is installed on the arm 18 side, and the tilt hinge 222 is installed on the radiation generation unit 20 side.

Thanks to the swivel hinge 220, the radiation generation unit 20 can be rotated in a predetermined rotation direction (G direction). As for the irradiation direction of the radiation generation unit 20, the radiation generation unit 20 can be rotated at least within the range of −90 degrees to +90 degrees with reference to the case where the irradiation direction of the radiation generation unit 20 is toward the floor with the arm 18 horizontal.

Thanks to the tilt hinge 222, the radiation generation unit 20 can be rotated in a predetermined rotation direction (F direction). The rotation axis in the F direction, which is the rotation axis of the tilt hinge 222, corresponds to the central axis of the arm 18. The rotation axis in the G direction of the swivel hinge 220 and the rotation axis in the F direction of the tilt hinge 222 are perpendicular to each other. By rotating the radiation generation unit 20 with the tilt hinge 222, the radiation generation unit 20 can be tilted to such an angle that the irradiation direction of the radiation generation unit 20 is toward the floor, even if the arm 18 is at any angle with respect to the supporting column 14.

When moving the radiation generation unit 20 from the position at the time of radiography of FIG. 1 to the position at the time of storage of FIG. 4, the operator rotates the radiation generation unit 20 with the swivel hinge 220 and the tilt hinge 222. Therefore, the radiation generation unit 20 can be located between the supporting column 14 and the supporting base 50. When the arm 18 is folded and the radiation generation unit 20 is stored, the radiation generation direction of the radiation generation unit 20 is a horizontal direction.

The swivel hinge 220 and the tilt hinge 222 are operable independently of each other. The swivel hinge 220 and the tilt hinge 222 can be torque hinges capable of freely keeping the position of the radiation generation unit 20. The swivel hinge 220 and the tilt hinge 222 may be, for example, torque hinges or damper hinges having low torque and having a lock mechanism capable of locking at any hinge opening angle. In addition, a lock mechanism capable of locking the radiation generation unit 20 only in a desired position may be provided.

The radiation generation unit 20 has a guide portion 42 and a guide portion 44 that are auxiliary portions capable of keeping the distance between the radiation generation unit 20 and the object constant. The operator can move the radiation generation unit 20 to a desired position by holding the guide portion 42 or the guide portion 44 and lifting or pulling the guide portion 42 or the guide portion 44.

The radiation generation apparatus of this embodiment includes a radiation generation unit 20 that generates radiation, and a supporting base 50 (moving portion 10) that supports a supporting mechanism that supports the radiation generation unit 20, and the supporting mechanism is removable from the supporting base (moving portion 10). The supporting mechanism is removable from the supporting base 50 (moving portion 10), together with a power source unit 30 that supplies power to the radiation generation unit 20.

If the supporting mechanism includes an arm 18 and a supporting column 14 supporting the arm 18, the supporting column 14 of the radiation generation apparatus of this embodiment is removable from the supporting base 50 (moving portion 10).

Therefore, the radiation generation apparatus of this embodiment can be carried in parts, and the radiation generation unit 20 can be easily installed according to the radiographing region of the object.

### Second Embodiment

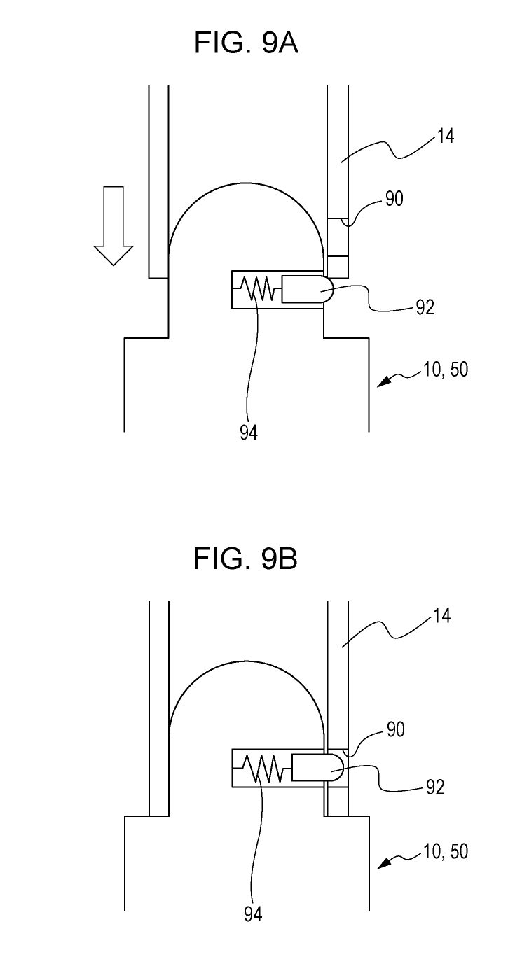

Next, a second embodiment will be described with reference to FIGS. 9A and 9B. The second embodiment differs from the first embodiment in that the fixing portion that fixes the connection portion 62 or 64 of the supporting base 50 or the moving portion 10 and the supporting column 14 is a plunger mechanism including a protruding portion 92 and a biasing member 94 that applies a force to the protruding portion 92.

The second embodiment is intended to eliminate the need to fix the supporting column 14 and the supporting base 50 or the moving portion 10 after connection.

Specifically, as shown in FIGS. 9A and 9B, a plunger mechanism having a protruding portion 92 having a predetermined width and a biasing member 94 that applies a force to the protruding portion 92 is provided. Although a spring is shown as an example of the biasing member 94, the biasing member 94 may be an elastic member made of rubber, or the like.

An insertion hole 90 is provided in the side surface of the supporting column 14. When the supporting column 14 is fitted on the connection portion, the protruding portion 92 of the plunger mechanism is pressed against the inner wall of the supporting column 14 by the biasing member 94. When the protruding portion 92 of the plunger mechanism is aligned with the insertion hole 90, the protruding portion 92 of the plunger mechanism is inserted into the insertion hole 90 by the force of the biasing member 94. Thanks to this structure of the plunger mechanism, even if a force is applied in such a direction that the connection portion of the supporting base 50 or the moving portion 10 and the supporting column 14 are separated, the supporting column 14 is not separated from the connection portion of the supporting base 50 or the moving portion 10 because the protruding portion 92 of the plunger mechanism is caught in the insertion hole 90. Therefore, the fixed state of the supporting base 50 or the moving portion 10 and the supporting column 14 can be kept.

When removing the supporting column 14 from the supporting base 50 or the moving portion 10, the operator presses the protruding portion 92 of the plunger mechanism toward the biasing member 94. By lifting the supporting column 14 in this state, the operator can remove the supporting column 14 from the supporting base 50 or the moving portion 10.

According to this embodiment, the fixing of the supporting column 14 and the supporting base 50 or the moving portion 10 can be easily performed.

### Third Embodiment

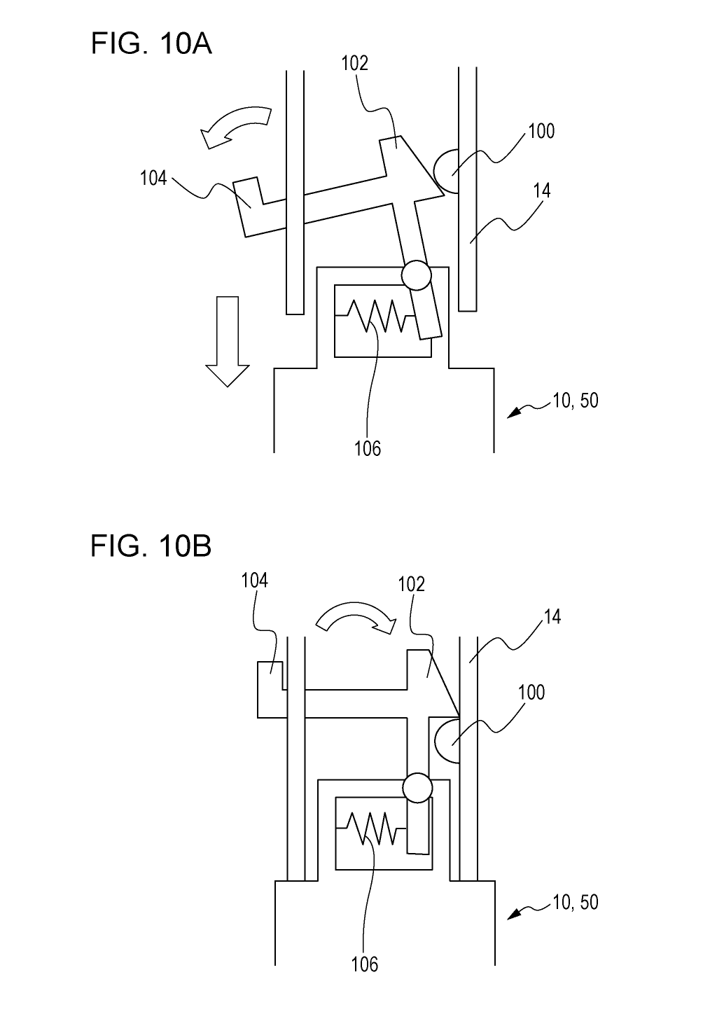

Next, a third embodiment will be described with reference to FIGS. 10A and 10B. The third embodiment differs from the first and second embodiments in that the fixing portion that fixes the connection portion of the supporting base 50 or the moving portion 10 and the supporting column 14 is a lock claw mechanism including a claw portion 102 that is caught on a fixing protrusion 100 inside the supporting column 14, and a biasing member 106 that applies a force to the claw portion 102.

The third embodiment is intended to eliminate the need to fix the supporting column 14 and the supporting base 50 or the moving portion 10 after connection.

As shown in FIGS. 10A and 10B, the supporting base 50 or the moving portion 10 of the radiation generation apparatus is provided with a lock claw mechanism including a claw portion 102 and a biasing member 106 that applies a force to the claw portion 102. Specifically, the lock claw mechanism includes a claw portion 102, a protruding portion 104 interlocking with the claw portion 102, and a biasing member 106 connected to the claw portion 102. Although a spring is shown as an example of the biasing member 106, the biasing member 106 may be an elastic member made of rubber, or the like.

A fixing protrusion 100 is provided inside (on the inner wall of) the hollow supporting column 14. The fixing protrusion 100 is a member on which the claw portion 102 is caught. The lock claw mechanism of the supporting base 50 or the moving portion 10 is normally vertically erected. The upper side of the claw portion 102 is an inclined surface. The inclined surface of the claw portion 102 is configured to come into contact with the fixing protrusion 100 and to slide thereon.

As shown in FIG. 10A, when the supporting column 14 is fitted on the connection portion of the supporting base 50 or the moving portion 10, the erected claw portion 102 of the lock claw mechanism is pressed by the fixing protrusion 100 from above. Therefore, the claw portion 102 of the lock claw mechanism is inclined away from the fixing protrusion 100. When the fixing protrusion 100 reaches the lower end of the claw portion 102 of the lock claw mechanism, the claw portion 102 of the lock claw mechanism is vertically erected again by the force of the biasing member 106. Thanks to this structure, even if a force is applied in such a direction that the connection portion of the supporting base 50 or the moving portion 10 and the supporting column 14 are separated, the supporting column 14 is not separated from the connection portion of the supporting base 50 or the moving portion 10 because the claw portion 102 of the lock claw mechanism is caught on the fixing protrusion 100. Therefore, the fixed state of the supporting base 50 or the moving portion 10 and the supporting column 14 can be kept.

When radiography is ended and the supporting column 14 is separated from the supporting base 50 or the moving portion 10 of the radiation generation apparatus, the protruding portion 104 interlocking with the claw portion 102 of the lock claw mechanism is operated. By operating the protruding portion 104, the claw portion 102 of the lock claw mechanism is inclined away from the fixing protrusion 100. At this time, the claw portion 102 of the lock claw mechanism, which is caught on the fixing protrusion 100 and fixed, is released from the fixed state.

By lifting the supporting column 14, the supporting column 14 can be removed from the supporting base 50 or the moving portion 10.

According to this embodiment, the fixing of the supporting column 14 and the supporting base 50 or the moving portion 10 can be easily performed.

### Fourth Embodiment

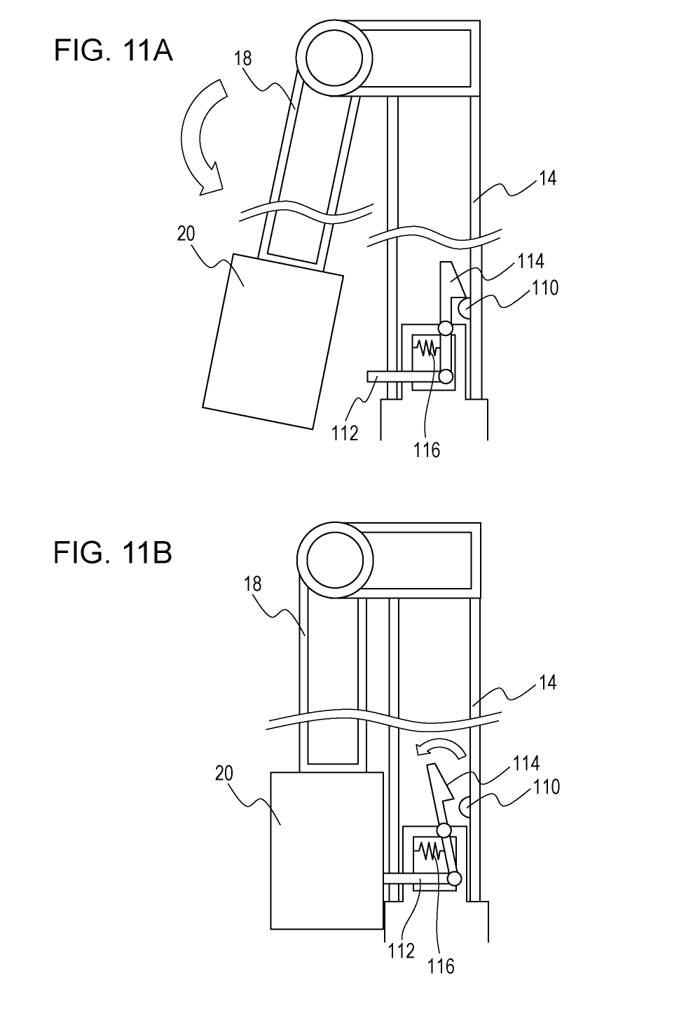

Next, a fourth embodiment will be described with reference to FIGS. 11A and 11B. The fourth embodiment differs from the first to third embodiments in that the fixing portion that fixes the connection portion 62 or 64 of the supporting base 50 or the moving portion 10 and the supporting column 14 is a combination of a lock claw mechanism and a link mechanism including a claw portion 114 that is caught on a fixing protrusion 110 inside the supporting column 14, a biasing member 116 that applies a force to the claw portion 114, and a release protrusion 112 that is installed outside the supporting column 14 and that releases the fixing of the claw portion 114.

The fourth embodiment is intended to eliminate the need to release the fixing of the supporting column 14 and the supporting base 50 or the moving portion 10 after connection.

As shown in FIG. 11A, a release protrusion 112 protruding to the outside of the supporting column 14 is provided. The release protrusion 112 is a member that operates the claw portion 114 and that releases the fixing of the claw portion 114. At the time of radiography, as shown in FIG. 11A, the radiation generation unit 20 is away from the supporting column 14. The lock claw mechanism is vertically erected, and the claw portion 114 of the lock claw mechanism is caught on the fixing protrusion 110. Since the claw portion 114 of the lock claw mechanism is caught on the fixing protrusion 110, the supporting column 14 is not separated from the connection portion of the supporting base 50 or the moving portion 10.

When radiography is ended and the arm 18 is lowered so as to become parallel to the supporting column 14 in order to store the radiation generation unit 20, the arm 18 or the radiation generation unit 20 pushes the release protrusion 112. By pushing the release protrusion 112, the claw portion 114 connected with the release protrusion 112 is inclined away from the fixing protrusion 110.

As described above, thanks to the lock claw mechanism and the link mechanism, during radiography, the supporting column 14 is prevented from being separated from the supporting base 50 or the moving portion 10 by an unintentional action. In addition, when the operator separates the supporting column 14 of the radiation generation apparatus, the need to release the fixing can be eliminated. Although a spring is shown as an example of the biasing member 116, the biasing member 116 may be an elastic member made of rubber, or the like.

According to this embodiment, the release of the fixing of the supporting column 14 and the supporting base 50 or the moving portion 10 can be facilitated.

A radiographic apparatus of the present invention includes a radiation generation apparatus, a detecting apparatus that detects radiation generated in a radiation generation unit and passing through an object and that outputs image data according to the radiation, and a display apparatus (not shown) that displays an image.

Examples of radiation include not only alpha rays, beta rays, gamma rays, and X-rays, which are beams formed by particles (including photons) emitted by radioactive decay, but also beams having energies comparable to or higher than the energies of the above-mentioned beams, such as particle rays and cosmic rays.

Although a distinction has been made between the arm 18 and the supporting column 14 in the radiographic apparatus of the present invention, the present invention is not limited to the arm 18 and the supporting column 14, and a single supporting mechanism having functions of the arm 18 and the supporting column 14 may be used. Such a supporting mechanism is a member capable of connecting the radiation generation unit 20 and the supporting base 50 or the moving portion 10 and capable of supporting the radiation generation unit 20. For example, such a supporting mechanism is a bellows structure having a predetermined rigidity, and is collapsible to store the radiation generation unit 20.

The radiation generation unit 20 is a transmission type radiation generation unit. In a transmission type radiation generation unit, in order to block unnecessary radiation, radiation blocking members are disposed on the electron incidence side and the radiation emission side of a target. In a transmission type radiation generation unit, it is not necessary to cover the entire periphery of a radiation generating tube or an envelope housing a radiation generating tube with a shielding member made of lead or the like. Therefore, a transmission type radiation generation unit is compact and lightweight compared to, for example, a rotating anode type radiation generation unit.

Since the radiation generation unit 20 is compact and lightweight, a heavy carriage is not needed. Even a supporting base 50 (moving portion 10) having a plurality of leg portions installed at predetermined intervals can keep the balance of the radiation generation apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-073014, filed Mar. 29, 2013, which is hereby incorporated by reference herein in its entirety.

What is claimed is:

1. A radiation generation apparatus comprising:
a supporting mechanism configured to support a radiation generation unit that generates radiation; and
a supporting base that supports the supporting mechanism,
wherein the supporting mechanism is removable from the supporting base together with a power source unit that supplies power to the radiation generation unit.

2. The radiation generation apparatus according to claim 1, wherein the supporting mechanism includes an arm that supports the radiation generation unit, and a supporting column that supports the arm.

3. The radiation generation apparatus according to claim 2, wherein the supporting base has a connection portion that is connected to the supporting column.

4. The radiation generation apparatus according to claim 3, wherein the connection portion is fitted into the supporting column.

5. The radiation generation apparatus according to claim 3, further comprising a fixing portion that fixes the connection portion and the supporting column.

6. The radiation generation apparatus according to claim 5, wherein the connection portion has a mechanism that secures the fixing portion.

7. The radiation generation apparatus according to claim 2, wherein the radiation generation unit is attached to the arm, and the power source unit is attached to the supporting column.

8. The radiation generation apparatus according to claim 7, wherein the power source unit is fixed to the supporting column above the supporting base.

9. The radiation generation apparatus according to claim 7, further comprising a rotating portion that rotates the radiation generation unit and that is installed between the radiation generation unit and the arm.

10. The radiation generation apparatus according to claim 7, wherein the power source unit is installed on a side surface of the supporting column such that the power source unit is not interfered by the arm and the radiation generation unit when the arm is folded.

11. The radiation generation apparatus according to claim 1, wherein the supporting base moves on a flat surface of a floor.

12. The radiation generation apparatus according to claim 5, wherein the fixing portion is a plunger mechanism including a protruding portion and a biasing member that applies a force to the protruding portion.

13. The radiation generation apparatus according to claim 5, wherein the fixing portion is a lock claw mechanism including a claw portion that is caught on a fixing protrusion inside the supporting column, and a biasing member that applies a force to the claw portion.

14. The radiation generation apparatus according to claim 13, further comprising a release protrusion that is installed outside the supporting column and that releases the fixing of the claw portion.

15. A radiation generation apparatus comprising:
a supporting mechanism that supports a radiation generation unit that generates radiation; and
a moving portion that supports the supporting mechanism and that moves on a floor,
wherein the supporting mechanism is removable from the moving portion.

16. A radiographic apparatus comprising:
the radiation generation apparatus according to claim 1;
a detecting apparatus that detects radiation passing through an object and that outputs image data according to the radiation, and
a display apparatus that displays an image based on the image data.
